(19) United States
(12) Patent Application Publication
(10) Pub. No.: US 2023/0410461 A1
(43) Pub. Date: Dec. 21, 2023

(54) EFFICIENT MULTI-SCALE ORB WITHOUT IMAGE RESIZING

(71) Applicants: Nithin Gollahalli Ananda, London (GB); Thomas Muttenthaler, Vienna (AT); Edward James Rosten, London (GB); Daniel Wolf, Mödling (AT)

(72) Inventors: Nithin Gollahalli Ananda, London (GB); Thomas Muttenthaler, Vienna (AT); Edward James Rosten, London (GB); Daniel Wolf, Mödling (AT)

(21) Appl. No.: 18/335,828

(22) Filed: Jun. 15, 2023

(30) Foreign Application Priority Data
Jun. 17, 2022 (IN) 202211034970

(51) Int. Cl. G06V 10/44; G06T 11/00; G06V 20/20; G06V 10/75

(52) U.S. Cl. CPC G06V 10/443; G06T 11/00; G06V 20/20; G06V 10/751

(57) ABSTRACT

A method for detecting a marker in a camera image is described. In one aspect, a method includes accessing a camera image generated by an optical sensor of an augmented reality (AR) device, accessing a query image from a storage of the AR device, and identifying, using a feature detector program, the query image in the camera image without scaling the camera image.

This application claims the benefit of priority to India Patent Application Serial No. 202211034970, filed on Jun. 17, 2022, which is incorporated herein by reference in its entirety.

### TECHNICAL FIELD

The subject matter disclosed herein generally relates to a computer vision system. Specifically, the present disclosure addresses systems and methods for detecting and tracking a visual marker in an image.

### BACKGROUND

An augmented reality (AR) device enables a user to observe a scene while simultaneously seeing relevant virtual content that may be anchored to items, images, objects, or environments in the field of view of the device. For example, the AR device detects an image of a known marker in an camera image and displays augmented data (e.g., 3D model of a virtual object) based on the marker location in the camera image.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an environment for operating an AR device in accordance with one example embodiment.

FIG. 2 is a block diagram illustrating an AR device in accordance with one example embodiment.

FIG. 3 is a block diagram illustrating a marker localization system in accordance with one example embodiment.

FIG. 4 is a block diagram illustrating an operation of the marker localization system in accordance with one example embodiment.

FIG. 5 is a flow diagram illustrating a method for detecting a marker in accordance with one example embodiment.

FIG. 6 illustrates an example of a marker image, a standard camera image, and a wide-angle image an aspect of the subject matter in accordance with one example embodiment.

FIG. 7 illustrates an example of a detector window for the camera image and a detector window for the marker image in accordance with one example embodiment.

FIG. 8 illustrates an example of an image pyramid in accordance with a prior art.

FIG. 9 illustrates another example of an image pyramid in accordance with a prior art.

FIG. 10 illustrates a marker detection operation comparison in accordance with one example embodiment.

FIG. 11 is block diagram showing a software architecture within which the present disclosure may be implemented, according to an example embodiment.

FIG. 12 is a diagrammatic representation of a machine in the form of a computer system within which a set of instructions may be executed for causing the machine to perform any one or more of the methodologies discussed herein, according to one example embodiment.

FIG. 13 illustrates a network environment in which a head-wearable device can be implemented according to one example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The term “augmented reality” (AR) is used herein to refer to an interactive experience of a real-world environment where physical objects that reside in the real-world are “augmented” or enhanced by computer-generated digital content (also referred to as virtual content or synthetic content). AR can also refer to a system that enables a combination of real and virtual worlds, real-time interaction, and 3D registration of virtual and real objects. A user of an AR system perceives virtual content that appears to be attached or interact with a real-world physical object.

The term “virtual reality” (VR) is used herein to refer to a simulation experience of a virtual world environment that is completely distinct from the real-world environment. Computer-generated digital content is displayed in the virtual world environment. VR also refers to a system that enables a user of a VR system to be completely immersed in the virtual world environment and to interact with virtual objects presented in the virtual world environment.

The term “AR application” is used herein to refer to a computer-operated application that enables an AR experience. The term “VR application” is used herein to refer to a computer-operated application that enables a VR experience. The term “AR/VR application” refers to a computer-operated application that enables a combination of an AR experience or a VR experience.

The term “visual tracking system” is used herein to refer to a computer-operated application or system that enables a system to track visual features identified in images captured by one or more cameras of the visual tracking system. The visual tracking system builds a model of a real-world environment based on the tracked visual features. Non-limiting examples of the visual tracking system include: a visual Simultaneous Localization and Mapping system (VSLAM), and Visual Odometry Inertial (VIO) system. VSLAM can be used to build a target from an environment, or a scene based on one or more cameras of the visual tracking system. VIO (also referred to as a visual-inertial tracking system, and visual-inertial odometry system) determines a latest pose (e.g., position and orientation) of a device based on data acquired from multiple sensors (e.g., optical sensors, inertial sensors) of the device.

The term “Inertial Measurement Unit” (IMU) is used herein to refer to a device that can report on the inertial status of a moving body including the acceleration, velocity, orientation, and position of the moving body. An IMU enables tracking of movement of a body by integrating the acceleration and the angular velocity measured by the IMU. IMU can also refer to a combination of accelerometers and gyroscopes that can determine and quantify linear acceleration and angular velocity, respectively. The values obtained from the IMUs gyroscopes can be processed to obtain the pitch, roll, and heading of the IMU and, therefore, of the body with which the IMU is associated. Signals from the IMU's accelerometers also can be processed to obtain velocity and displacement of the IMU.

Both AR and VR applications allow a user to access information, such as in the form of virtual content rendered in a display of an AR/VR display device (also referred to as a display device). The rendering of the virtual content may be based on a position of the display device relative to a physical object or relative to a frame of reference (external to the display device) so that the virtual content correctly appears in the display. For AR, the virtual content appears anchored to a real-world physical object as perceived by the user and a camera of the AR display device. The virtual content appears to be attached/anchored to the physical world (e.g., a physical object of interest). To do this, the AR display device detects the physical object and tracks a pose of the AR display device relative to the position of the physical object. A pose identifies a position and orientation of the display device relative to a frame of reference or relative to another object. For VR, the virtual object appears at a location based on the pose of the VR display device. The virtual content is therefore refreshed based on the latest pose of the device. A visual tracking system at the display device determines the pose of the display device. An example of a visual tracking system includes a visual-inertial tracking system (also referred to as visual-inertial odometry system) that relies on data acquired from multiple sensors (e.g., optical sensors, inertial sensors).

The terms “marker” and “visual marker” are used herein to refer to a pre-defined visual code or image. For example, some visual markers include graphic symbols designed to be easily recognized by machines. By scanning a visual marker through a camera phone, users can retrieve localized information and access mobile services (e.g., augmented content that is displayed and appears anchored to the marker).

A method for detecting a marker in a camera image is described. In one aspect, a method includes accessing a camera image generated by an optical sensor of an augmented reality (AR) device, accessing a query image from a storage of the AR device, and identifying, using a feature detector program, the query image in the camera image without scaling the camera image. The method further includes: scaling a detector window of the feature detector program, and extracting features from the camera image by scanning the unscaled camera image with the (one or more different size) scaled detectors.

As a result, one or more of the methodologies described herein facilitate solving the technical problem of power consumption saving by avoiding the computation-intensive image pyramid process of a camera image. The presently described method provides an improvement to an operation of the functioning of a computer by providing power consumption reduction. As such, one or more of the methodologies described herein may obviate a need for certain efforts or computing resources. Examples of such computing resources include Processor cycles, network traffic, memory usage, data storage capacity, power consumption, network bandwidth, and cooling capacity.

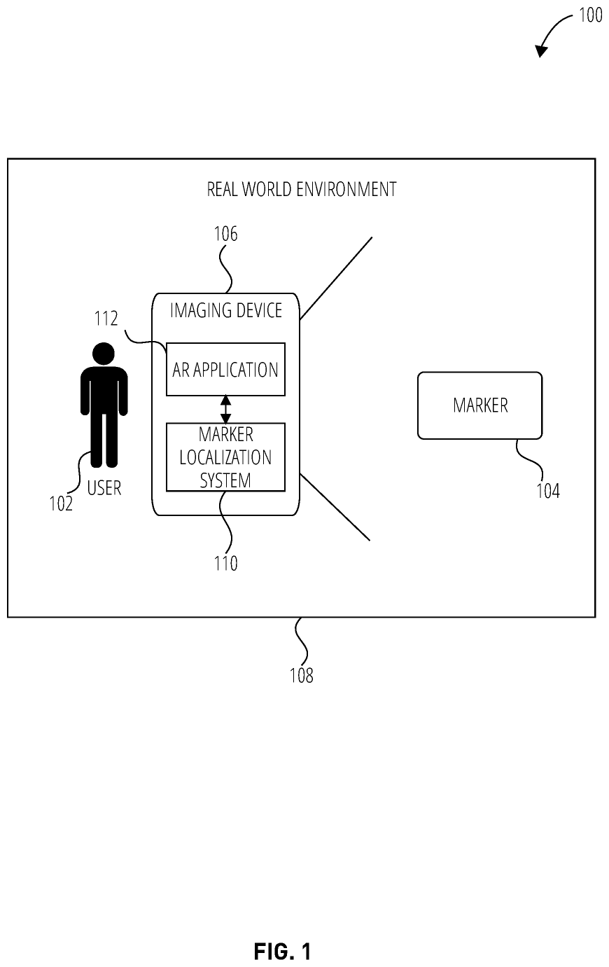

FIG. 1 is a network diagram illustrating an environment 100 suitable for operating an imaging device 106, according to some example embodiments. The environment 100 includes a user 102, an imaging device 106, and a marker 104. A user 102 operates the imaging device 106. The user 102 may be a human user (e.g., a human being), a machine user (e.g., a computer configured by a software program to interact with the imaging device 106), or any suitable combination thereof (e.g., a human assisted by a machine or a machine supervised by a human). The user 102 is associated with the imaging device 106.

The imaging device 106 may be a computing device with a display such as a smartphone, a tablet computer, or a wearable computing device (e.g., watch or glasses). The computing device may be hand-held or may be removable mounted to a head of the user 102. In one example, the display includes a screen that displays images captured with a camera of the imaging device 106. In another example, the display of the device may be transparent such as in lenses of wearable computing glasses. In other examples, the display may be non-transparent, partially transparent, partially opaque. In yet other examples, the display may be wearable by the user 102 to cover a portion of the field of vision of the user 102.

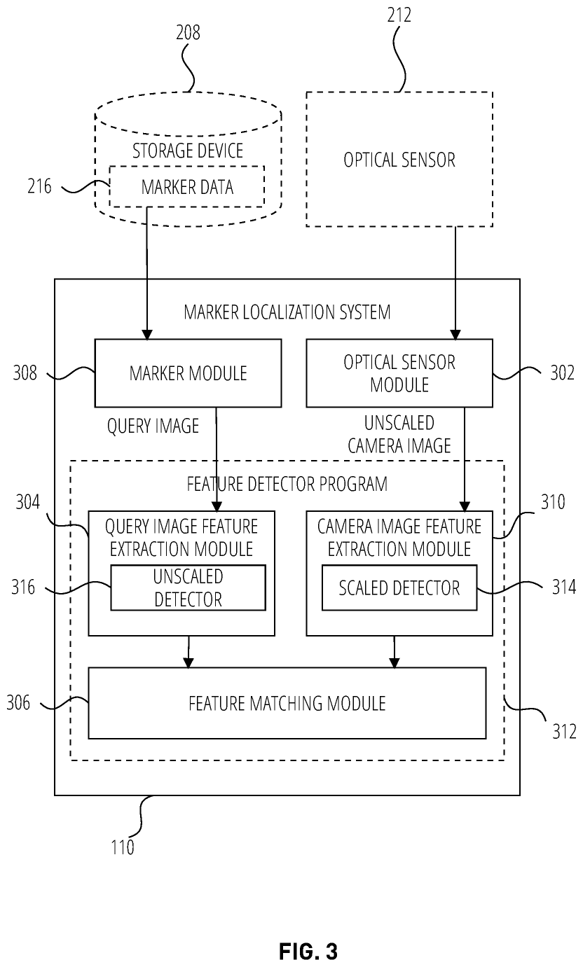

The imaging device 106 includes an AR application 112 and a marker localization system 110. The marker localization system 110 detects the marker 104 in an image captured by a camera of the imaging device 106. In one example, the marker localization system 110 identifies, using a feature detector program (shown in FIG. 3), a query image in the image without scaling the image. The marker localization system 110 is described below with respect to FIG. 3.

The AR application 112 generates virtual content based on the marker 104 detected with the camera of the imaging device 106. For example, the user 102 can aim the optical sensor 212 to capture an image of the marker 104. The AR application 112 generates virtual content corresponding to the marker 104 and displays the virtual content in a display 204 of the imaging device 106.

The AR application 112 tracks the pose (e.g., position and orientation) of the imaging device 106 relative to the real world environment 108 using, for example, optical sensors (e.g., depth-enabled 3D camera, image camera), inertia sensors (e.g., gyroscope, accelerometer), wireless sensors (Bluetooth, Wi-Fi), GPS sensor, and audio sensor. In one example, the imaging device 106 displays virtual content based on the pose of the imaging device 106 relative to the real world environment 108 and/or the marker 104.

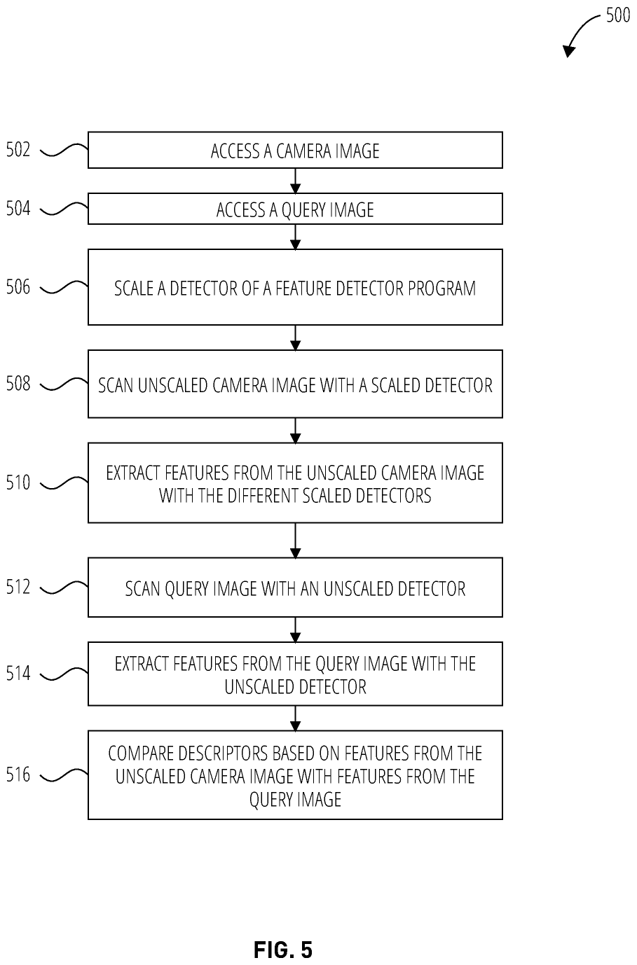

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 5. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The imaging device 106 may operate over a computer network. The computer network may be any network that enables communication between or among machines, databases, and devices. Accordingly, the computer network may be a wired network, a wireless network (e.g., a mobile or cellular network), or any suitable combination thereof. The computer network may include one or more portions that constitute a private network, a public network (e.g., the Internet), or any suitable combination thereof.

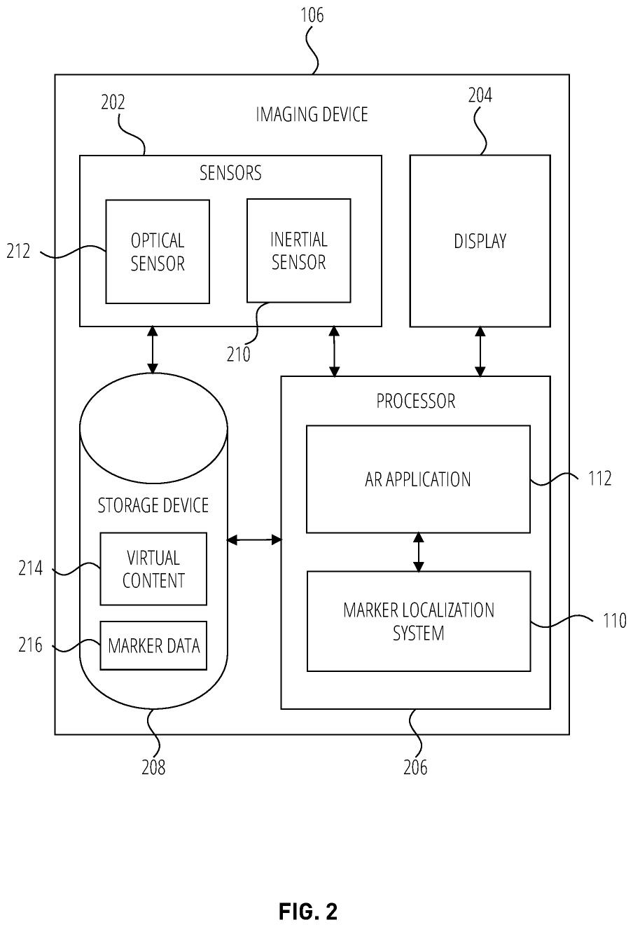

FIG. 2 is a block diagram illustrating modules (e.g., components) of the imaging device 106, according to some example embodiments. The imaging device 106 includes sensors 202, a display 204, a processor 206, and a storage device 208. Examples of imaging device 106 include a wearable computing device, a mobile computing device, or a smart phone.

The sensors 202 include, for example, an optical sensor 212 (e.g., a wide-angle camera, a standard angle camera, a narrow-angle camera, a depth sensor) and an inertial sensor 210 (e.g., gyroscope, accelerometer, magnetometer). The optical sensor 212 generates an image referred to as a “camera image.” Other examples of sensors 202 include a proximity or location sensor (e.g., near field communication, GPS, Bluetooth, Wifi), an audio sensor (e.g., a microphone), a thermal sensor, a pressure sensor (e.g., barometer), or any suitable combination thereof. It is noted that the sensors 202 described herein are for illustration purposes and the sensors 202 are thus not limited to the ones described above.

The display 204 includes a screen or monitor configured to display images generated by the processor 206. In one example embodiment, the display 204 may be transparent or semi-opaque so that the user 102 can see through the display 204 (in AR use case). In another example embodiment, the display 204 covers the eyes of the user 102 and blocks out the entire field of view of the user 102 (in VR use case). In another example, the display 204 includes a touchscreen display configured to receive a user input via a contact on the touchscreen display.

The processor 206 includes an AR application 112 and a marker localization system 110. The AR application 112 detects and identifies a physical environment or the marker 104 using computer vision. The AR application 112 retrieves virtual content (e.g., 3D object model) based on the identified marker 104 or the physical environment. The AR application 112 renders the virtual object in the display 204. In one example embodiment, the AR application 112 includes a local rendering engine that generates a visualization of virtual content overlaid (e.g., superimposed upon, or otherwise displayed in tandem with) on an image of the marker 104 captured by the optical sensor 212. A visualization of the virtual content may be manipulated by adjusting a position of the marker 104 (e.g., its physical location, orientation, or both) relative to the imaging device 106. Similarly, the visualization of the virtual content may be manipulated by adjusting a pose of the imaging device 106 relative to the marker 104.

The marker localization system 110 detects and identifies the marker 104. For example, the marker localization system 110 retrieves a marker image and compares it with image data from the camera image to detect the marker 104 and the location of the marker 104 in the camera image. In one example, the marker localization system 110 does not resize or scale the camera image but rather maintains the size of the camera image fixed (e.g., unscaled) and scale the descriptor/detector window of the feature extraction process of the marker localization system 110. One example of a feature detector algorithm includes ORB (Oriented FAST and rotated BRIEF). The marker localization system 110 is described in more detail below with respect to FIG. 3.

The storage device 208 stores virtual content 214 and marker data 216. For example, the marker data 216 includes a pre-defined image of the marker 104. The virtual content 214 includes, for example, a database of visual references (e.g., images of physical objects) and corresponding experiences (e.g., three-dimensional virtual object models).

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

FIG. 3 is a block diagram illustrating a marker localization system 110 in accordance with one example embodiment. The marker localization system 110 includes a marker module 308, optical sensor module 302, and a feature detector program 312.

The marker module 308 retrieves a marker image from marker data 216. The marker image is also referred to as a query image. The optical sensor module 302 retrieves a camera image from the optical sensor 212. The camera image remains unscaled and is in the originally captured scale. The camera image is also referred to as unscaled camera image.

In computer vision, after interesting keypoints are detected in an image, each keypoint is described with a unique feature. This feature (mathematically a 1-D vector) is called a descriptor and those of ordinary skills in the art will recognize that there are several techniques to calculate the descriptor.

The feature detector program 312 includes a query image feature extraction module 304 and a camera image feature extraction module 310, and a feature matching module 306. The query image feature extraction module 304 scans the query image using a fixed size detector window (e.g., unscaled detector 316). The camera image feature extraction module 310 scans the unscaled camera image with the scaled detector 314. The feature matching module 306 compares and matches the extracted features of the query image from the query image feature extraction module 304 with the unscaled camera image from the camera image feature extraction module 310.

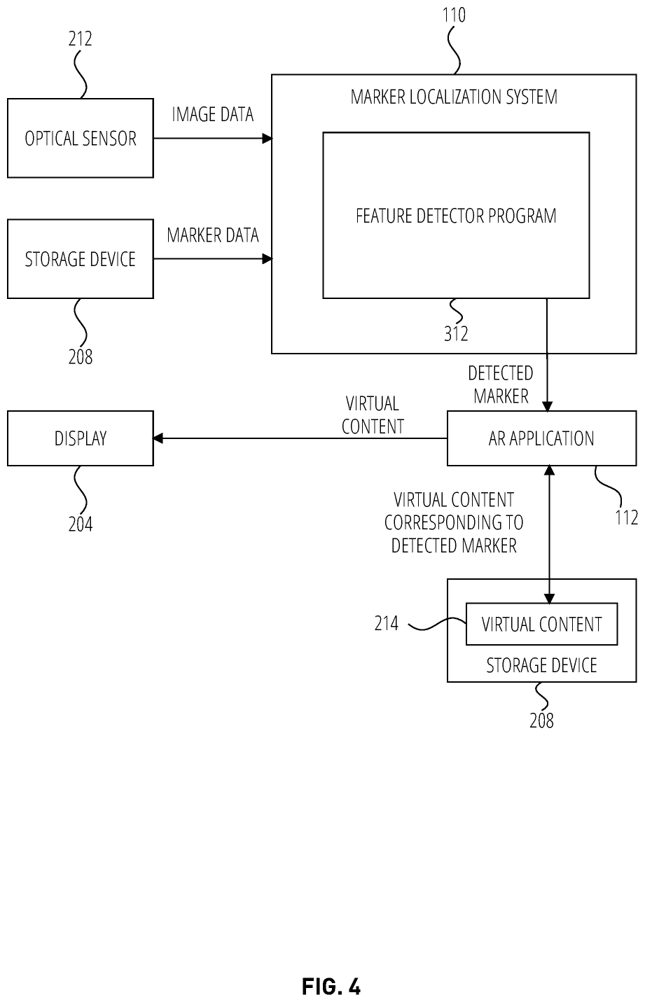

FIG. 4 is a block diagram illustrating an operation of the marker localization system 110 in accordance with one example embodiment. The marker localization system 110 retrieves image data (e.g., camera image) from the optical sensor 212 and marker data (e.g., query image) from the storage device 208.

The feature detector program 312 detects the marker image in the image data. The feature detector program 312 confirms the location of the detected marker in the image data to the AR application 112.

The AR application 112 retrieves virtual content 214 (corresponding to the detected marker) from the storage device 208 and causes the virtual content 214 to be displayed at a location (in the display 204) based on the location of the marker in the camera image.

FIG. 5 is a flow diagram illustrating a method 500 for comparing descriptors in accordance with one example embodiment. Operations in the method 500 may be performed by the marker localization system 110, using components (e.g., modules, engines) described above with respect to FIG. 3. Accordingly, the method 500 is described by way of example with reference to the marker localization system 110. However, it shall be appreciated that at least some of the operations of the method 500 may be deployed on various other hardware configurations or be performed by similar components residing elsewhere.

In block 502, the optical sensor module 302 accesses a camera image from the optical sensor 212. In block 504, the marker module 308 accesses a query image. In block 506, the camera image feature extraction module 310 scales a detector window of a feature detector program (e.g., feature detector program 312). In block 508, the camera image feature extraction module 310 scans the unscaled camera image with a scaled detector window. In block 510, the camera image feature extraction module 310 extracts features from the unscaled camera image with the scaled detector window. In block 512, the query image feature extraction module 304 scans a query image with an unscaled fixed sized window (e.g., the size of the fixed sized window is larger than the size of the scaled detector window). In block 514, the query image feature extraction module 304 extracts features from the query image with the unscaled fixed sized window. In block 516, the feature matching module 306 compares descriptors based on features from the unscaled camera image with features from the query image.

It is to be noted that other embodiments may use different sequencing, additional or fewer operations, and different nomenclature or terminology to accomplish similar functions. In some embodiments, various operations may be performed in parallel with other operations, either in a synchronous or asynchronous manner. The operations described herein were chosen to illustrate some principles of operations in a simplified form.

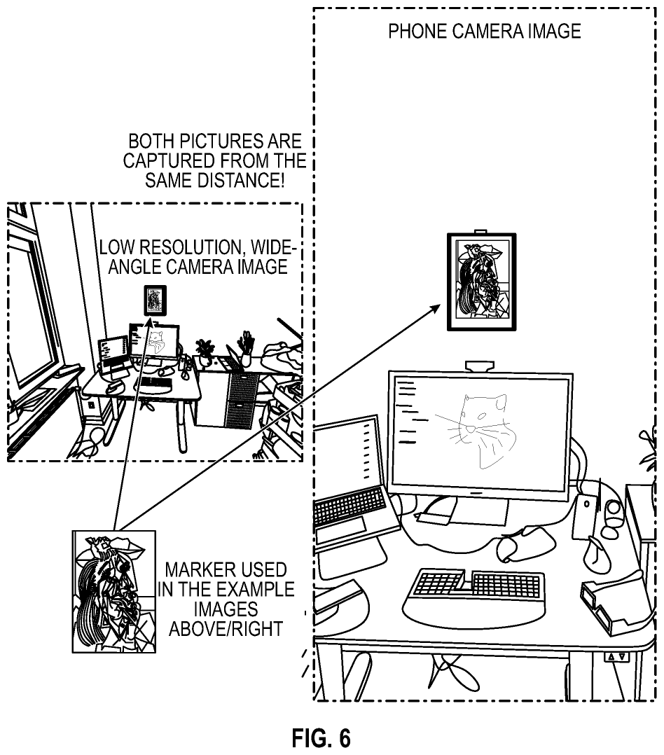

FIG. 6 illustrates an example of a marker image, a standard camera image, and a wide-angle image an aspect of the subject matter in accordance with one example embodiment. The marker is small on low resolution, wide-angle cameras compared to “standard” cameras like a phone and therefore difficult to localize.

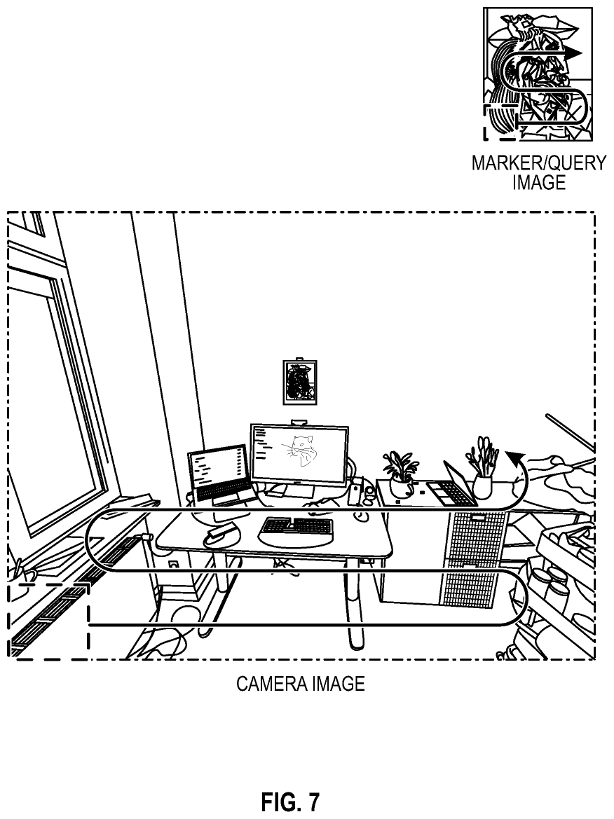

FIG. 7 illustrates an example of a detector window for the camera image and a detector window for the marker image in accordance with one example embodiment. ORB is a feature extraction pipeline that can be used to extract distinct features of an image, which can in turn be used to match (find/localize) certain patterns in an image, such as a pre-defined marker.

Information is extracted by a window which scans the image. In ORB this consists of two stages:

Keypoint detection: finds interesting, descriptive points in an image (ORB uses FAST for that)

Descriptor calculation: Pixels around the keypoints are combined and stored into a descriptor. (ORB uses the rBRIEF descriptor)

An example ORB operation includes:
(1) Query image is scanned by a fixed size window (green square in images on the right). Information is extracted and stored.
(2) Camera image is scanned by a fixed size window. Information is extracted and stored

Information from 1) and 2) is compared/matched in order to locate the query image in the camera image.

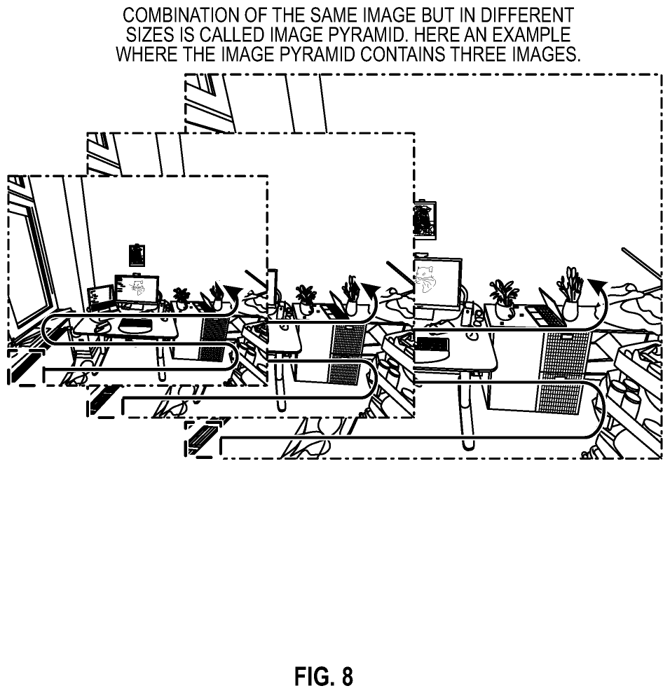

FIG. 8 illustrates an example of an image pyramid in accordance with a prior art. To make the algorithm more robust and extend the distance range, ORB uses the same image in different sizes to extract information (e.g., it computes an image pyramid). But calculating all the different image sizes is expensive.

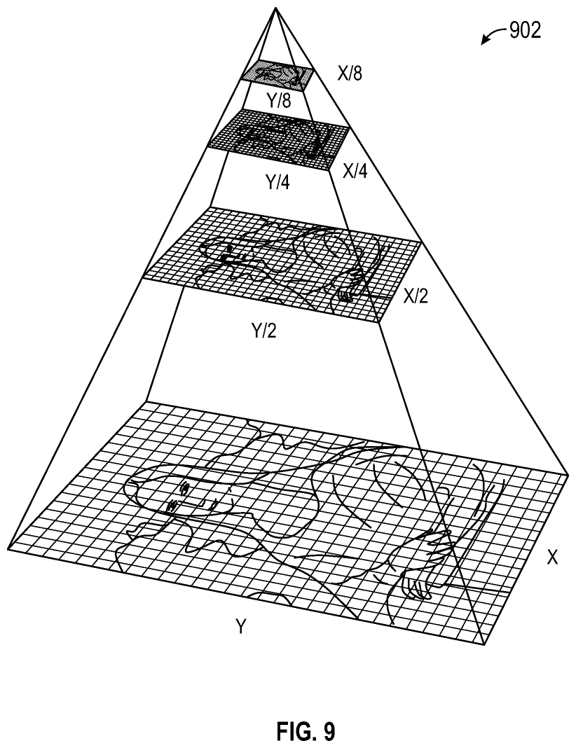

FIG. 9 illustrates another example of an image pyramid in accordance with a prior art.

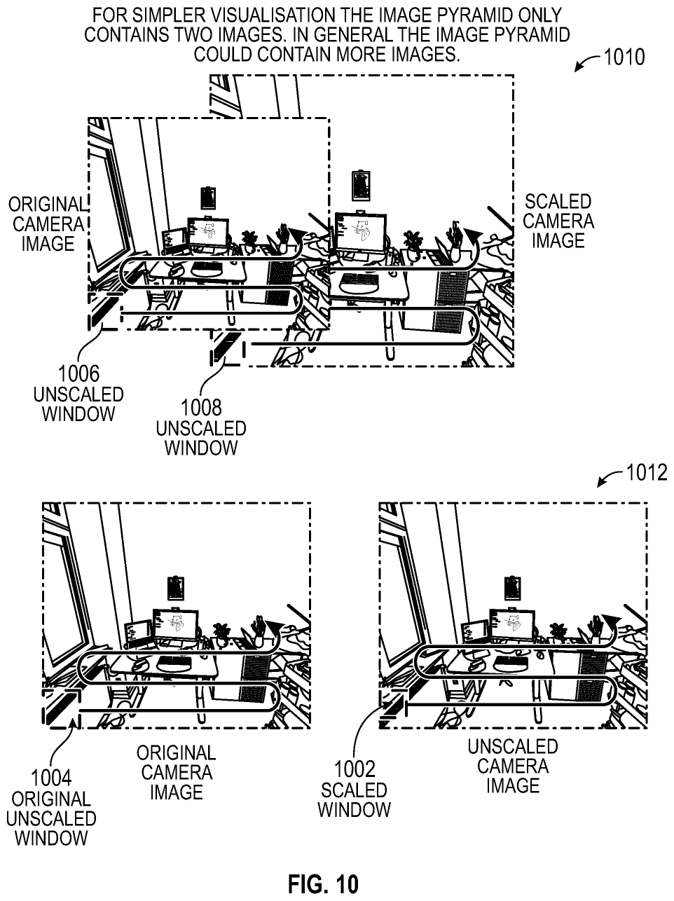

FIG. 10 illustrates a marker detection operation comparison (of conventional image scaling 1010 and detector window scaling 1012) in accordance with one example embodiment.

In conventional image scaling 1010, the process includes upscaling camera image and running ORB:
Upscale image
Calculate image pyramid
Run ORB with fixed size window on all image scales

In detector window scaling 1012, the process does not perform any upscaling, reduces/eliminates required image pyramid levels, and runs ORB with scaled windows only on the original camera image.

In 1012, the scaled window 1002 can include different scaled-size detectors.

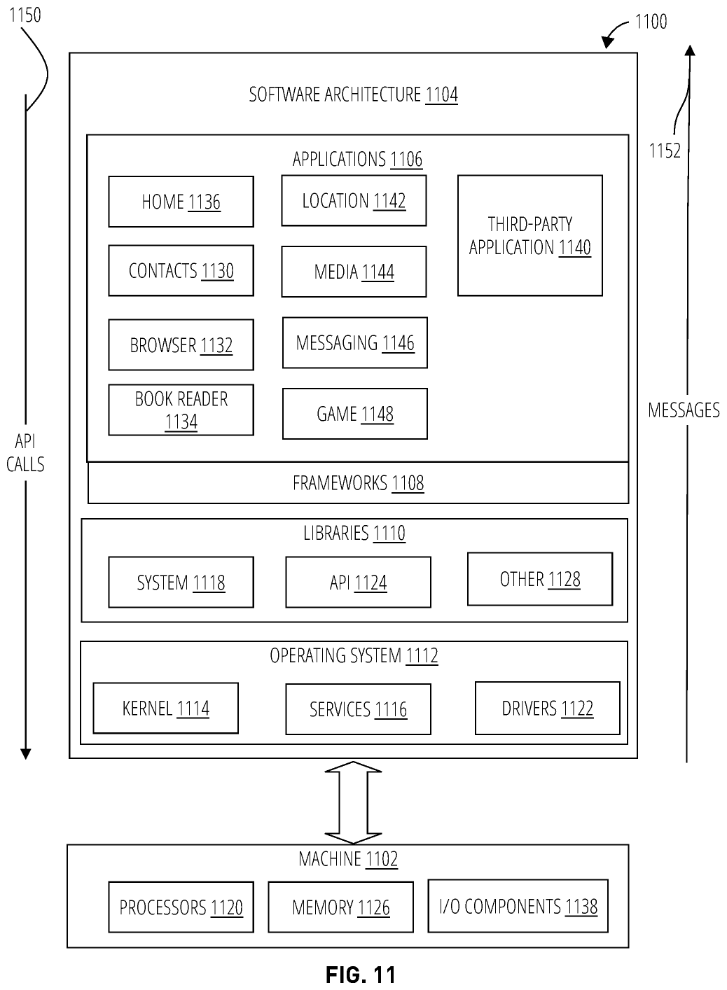

FIG. 11 is a block diagram 1100 illustrating a software architecture 1104, which can be installed on any one or more of the devices described herein. The software architecture 1104 is supported by hardware such as a machine 1102 that includes Processors 1120, memory 1126, and I/O Components 1138. In this example, the software architecture 1104 can be conceptualized as a stack of layers, where each layer provides a particular functionality. The software architecture 1104 includes layers such as an operating system 1112, libraries 1110, frameworks 1108, and applications 1106. Operationally, the applications 1106 invoke API calls 1150 through the software stack and receive messages 1152 in response to the API calls 1150.

The operating system 1112 manages hardware resources and provides common services. The operating system 1112 includes, for example, a kernel 1114, services 1116, and drivers 1122. The kernel 1114 acts as an abstraction layer between the hardware and the other software layers. For example, the kernel 1114 provides memory management, Processor management (e.g., scheduling), Component management, networking, and security settings, among other functionalities. The services 1116 can provide other common services for the other software layers. The drivers 1122 are responsible for controlling or interfacing with the underlying hardware. For instance, the drivers 1122 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1110 provide a low-level common infrastructure used by the applications 1106. The libraries 1110 can include system libraries 1118 (e.g., C standard library) that provide functions such as memory allocation functions, string manipulation functions, mathematic functions, and the like. In addition, the libraries 1110 can include API libraries 1124 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1110 can also include a wide variety of other libraries 1128 to provide many other APIs to the applications 1106.

The frameworks 1108 provide a high-level common infrastructure that is used by the applications 1106. For example, the frameworks 1108 provide various graphical user interface (GUI) functions, high-level resource management, and high-level location services. The frameworks 1108 can provide a broad spectrum of other APIs that can be used by the applications 1106, some of which may be specific to a particular operating system or platform.

In an example embodiment, the applications 1106 may include a home application 1136, a contacts application 1130, a browser application 1132, a book reader application 1134, a location application 1142, a media application 1144, a messaging application 1146, a game application 1148, and a broad assortment of other applications such as a third-party application 1140. The applications 1106 are programs that execute functions defined in the programs. Various programming languages can be employed to create one or more of the applications 1106, structured in a variety of manners, such as object-oriented programming languages (e.g., Objective-C, Java, or C++) or procedural programming languages (e.g., C or assembly language). In a specific example, the third-party application 1140 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1140 can invoke the API calls 1150 provided by the operating system 1112 to facilitate functionality described herein.

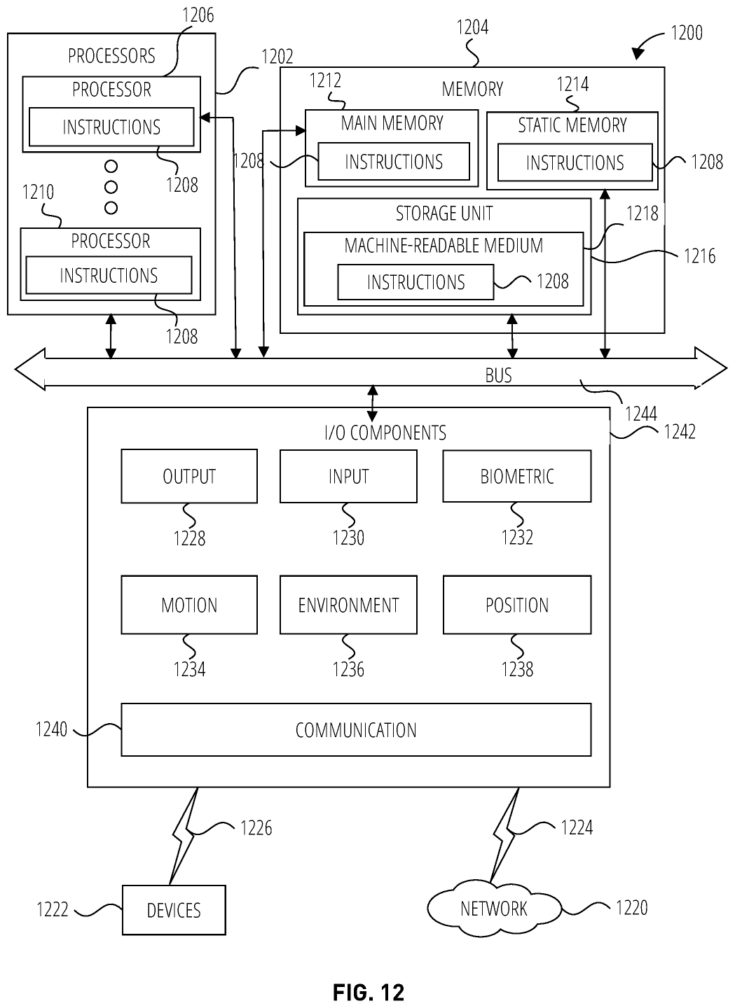

FIG. 12 is a diagrammatic representation of the machine 1200 within which instructions 1208 (e.g., software, a program, an application, an applet, an app, or other executable code) for causing the machine 1200 to perform any one or more of the methodologies discussed herein may be executed. For example, the instructions 1208 may cause the machine 1200 to execute any one or more of the methods described herein. The instructions 1208 transform the general, non-programmed machine 1200 into a particular machine 1200 programmed to carry out the described and illustrated functions in the manner described. The machine 1200 may operate as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1208, sequentially or otherwise, that specify actions to be taken by the machine 1200. Further, while only a single machine 1200 is illustrated, the term “machine” shall also be taken to include a collection of machines that individually or jointly execute the instructions 1208 to perform any one or more of the methodologies discussed herein.

The machine 1200 may include Processors 1202, memory 1204, and I/O Components 1242, which may be configured to communicate with each other via a bus 1244. In an example embodiment, the Processors 1202 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an ASIC, a Radio-Frequency Integrated Circuit (RFIC), another Processor, or any suitable combination thereof) may include, for example, a Processor 1206 and a Processor 1210 that execute the instructions 1208. The term “Processor” is intended to include multi-core Processors that may comprise two or more independent Processors (sometimes referred to as “cores”) that may execute instructions contemporaneously. Although FIG. 12 shows multiple Processors 1202, the machine 1200 may include a single Processor with a single core, a single Processor with multiple cores (e.g., a multi-core Processor), multiple Processors with a single core, multiple Processors with multiples cores, or any combination thereof.

The memory 1204 includes a main memory 1212, a static memory 1214, and a storage unit 1216, both accessible to the Processors 1202 via the bus 1244. The main memory 1204, the static memory 1214, and storage unit 1216 store the instructions 1208 embodying any one or more of the methodologies or functions described herein. The instructions 1208 may also reside, completely or partially, within the main memory 1212, within the static memory 1214, within machine-readable medium 1218 within the storage unit 1216, within at least one of the Processors 1202 (e.g., within the Processor's cache memory), or any suitable combination thereof, during execution thereof by the machine 1200.

The I/O Components 1242 may include a wide variety of Components to receive input, provide output, produce output, transmit information, exchange information, capture measurements, and so on. The specific I/O Components 1242 that are included in a particular machine will depend on the type of machine. For example, portable machines such as mobile phones may include a touch input device or other such input mechanisms, while a headless server machine will likely not include such a touch input device. It will be appreciated that the I/O Components 1242 may include many other Components that are not shown in FIG. 12. In various example embodiments, the I/O Components 1242 may include output Components 1228 and input Components 1230. The output Components 1228 may include visual Components (e.g., a display such as a plasma display panel (PDP), a light emitting diode (LED) display, a liquid crystal display (LCD), a projector, or a cathode ray tube (CRT)), acoustic Components (e.g., speakers), haptic Components (e.g., a vibratory motor, resistance mechanisms), other signal generators, and so forth. The input Components 1230 may include alphanumeric input Components (e.g., a keyboard, a touch screen configured to receive alphanumeric input, a photo-optical keyboard, or other alphanumeric input Components), point-based input Components (e.g., a mouse, a touchpad, a trackball, a joystick, a motion sensor, or another pointing instrument), tactile input Components (e.g., a physical button, a touch screen that provides location and/or force of touches or touch gestures, or other tactile input Components), audio input Components (e.g., a microphone), and the like.

In further example embodiments, the I/O Components 1242 may include biometric Components 1232, motion Components 1234, environmental Components 1236, or position Components 1238, among a wide array of other Components. For example, the biometric Components 1232 include Components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion Components 1234 include acceleration sensor Components (e.g., accelerometer), gravitation sensor Components, rotation sensor Components (e.g., gyroscope), and so forth. The environmental Components 1236 include, for example, illumination sensor Components (e.g., photometer), temperature sensor Components (e.g., one or more thermometers that detect ambient temperature), humidity sensor Components, pressure sensor Components (e.g., barometer), acoustic sensor Components (e.g., one or more microphones that detect background noise), proximity sensor Components (e.g., infrared sensors that detect nearby objects), gas sensors (e.g., gas detection sensors to detection concentrations of hazardous gases for safety or to measure pollutants in the atmosphere), or other Components that may provide indications, measurements, or signals corresponding to a surrounding physical environment. The position Components 1238 include location sensor Components (e.g., a GPS receiver Component), altitude sensor Components (e.g., altimeters or barometers that detect air pressure from which altitude may be derived), orientation sensor Components (e.g., magnetometers), and the like.

Communication may be implemented using a wide variety of technologies. The I/O Components 1242 further include communication Components 1240 operable to couple the machine 1200 to a network 1220 or devices 1222 via a coupling 1224 and a coupling 1226, respectively. For example, the communication Components 1240 may include a network interface Component or another suitable device to interface with the network 1220. In further examples, the communication Components 1240 may include wired communication Components, wireless communication Components, cellular communication Components, Near Field Communication (NFC) Components, Bluetooth® Components (e.g., Bluetooth® Low Energy), WiFi® Components, and other communication Components to provide communication via other modalities. The devices 1222 may be another machine or any of a wide variety of peripheral devices (e.g., a peripheral device coupled via a USB).

Moreover, the communication Components 1240 may detect identifiers or include Components operable to detect identifiers. For example, the communication Components 1240 may include Radio Frequency Identification (RFID) tag reader Components, NFC smart tag detection Components, optical reader Components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection Components (e.g., microphones to identify tagged audio signals). In addition, a variety of information may be derived via the communication Components 1240, such as location via Internet Protocol (IP) geolocation, location via Wi-Fi® signal triangulation, location via detecting an NFC beacon signal that may indicate a particular location, and so forth.

The various memories (e.g., memory 1204, main memory 1212, static memory 1214, and/or memory of the Processors 1202) and/or storage unit 1216 may store one or more sets of instructions and data structures (e.g., software) embodying or used by any one or more of the methodologies or functions described herein. These instructions (e.g., the instructions 1208), when executed by Processors 1202, cause various operations to implement the disclosed embodiments.

The instructions 1208 may be transmitted or received over the network 1220, using a transmission medium, via a network interface device (e.g., a network interface Component included in the communication Components 1240) and using any one of a number of well-known transfer protocols (e.g., hypertext transfer protocol (HTTP)). Similarly, the instructions 1208 may be transmitted or received using a transmission medium via the coupling 1226 (e.g., a peer-to-peer coupling) to the devices 1222.

As used herein, the terms “Machine-Storage Medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of Machine-Storage Media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “Machine-Storage Media,” “computer-storage media,” and “device-storage media” specifically exclude carrier waves, modulated data signals, and other such media, at least some of which are covered under the term “signal medium” discussed below.

The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1416 for execution by the machine 1400, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “Computer-Readable Medium,” and “device-readable medium” mean the same thing and may be used interchangeably in this disclosure. The terms are defined to include both Machine-Storage Media and transmission media. Thus, the terms include both storage devices/media and carrier waves/modulated data signals.

System with Head-Wearable Apparatus

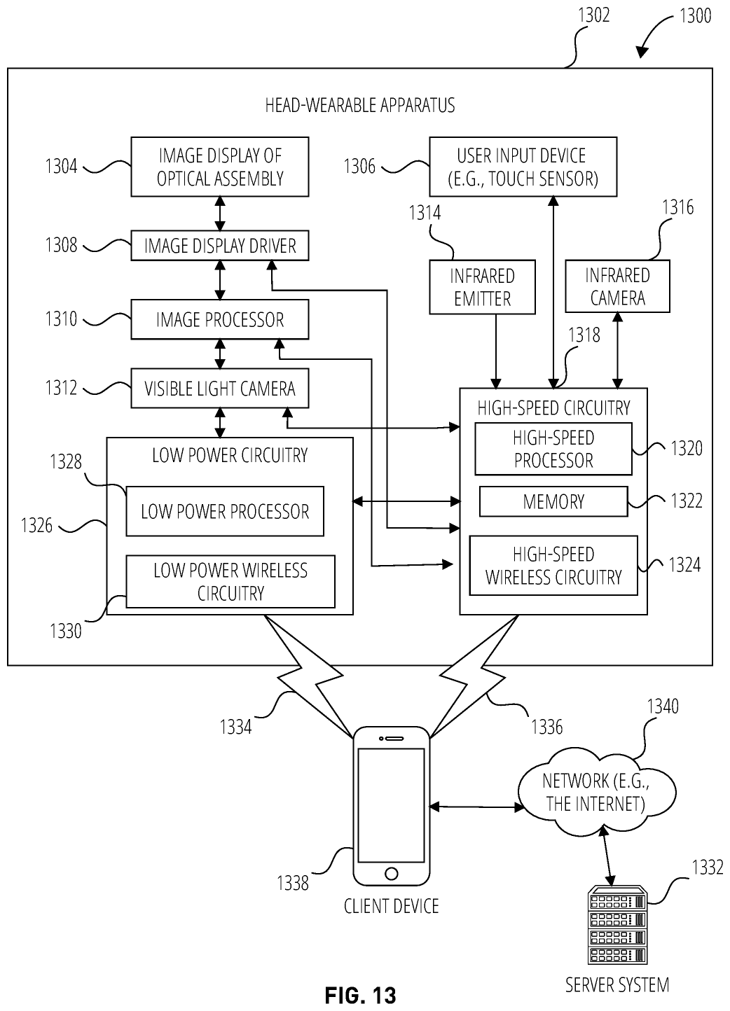

FIG. 13 illustrates a network environment 1300 in which the head-wearable apparatus 1302 can be implemented according to one example embodiment. FIG. 13 is a high-level functional block diagram of an example head-wearable apparatus 1302 communicatively coupled a mobile client device 1338 and a server system 1332 via various network 1340.
head-wearable apparatus 1302 includes a camera, such as at least one of visible light camera 1312, infrared emitter 1314 and infrared camera 1316. The client device 1338 can be capable of connecting with head-wearable apparatus 1302 using both a communication 1334 and a communication 1336. client device 1338 is connected to server system 1332 and network 1340. The network 1340 may include any combination of wired and wireless connections.

The head-wearable apparatus 1302 further includes two image displays of the image display of optical assembly 1304. The two include one associated with the left lateral side and one associated with the right lateral side of the head-wearable apparatus 1302. The head-wearable apparatus 1302 also includes image display driver 1308, image processor 1310, low-power low power circuitry 1326, and high-speed circuitry 1318. The image display of optical assembly 1304 are for presenting images and videos, including an image that can include a graphical user interface to a user of the head-wearable apparatus 1302.

The image display driver 1308 commands and controls the image display of the image display of optical assembly 1304. The image display driver 1308 may deliver image data directly to the image display of the image display of optical assembly 1304 for presentation or may have to convert the image data into a signal or data format suitable for delivery to the image display device. For example, the image data may be video data formatted according to compression formats, such as H. 264 (MPEG-4), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (Exif) or the like.

As noted above, head-wearable apparatus 1302 includes a frame and stems (or temples) extending from a lateral side of the frame. The head-wearable apparatus 1302 further includes a user input device 1306 (e.g., touch sensor or push button) including an input surface on the head-wearable apparatus 1302. The user input device 1306 (e.g., touch sensor or push button) is to receive from the user an input selection to manipulate the graphical user interface of the presented image.

The components shown in FIG. 13 for the head-wearable apparatus 1302 are located on one or more circuit boards, for example a PCB or flexible PCB, in the rims or temples. Alternatively, or additionally, the depicted components can be located in the chunks, frames, hinges, or bridge of the head-wearable apparatus 1302. Left and right can include digital camera elements such as a complementary metal-oxide-semiconductor (CMOS) image sensor, charge coupled device, a camera lens, or any other respective visible or light capturing elements that may be used to capture data, including images of scenes with unknown objects.

The head-wearable apparatus 1302 includes a memory 1322 which stores instructions to perform a subset or all of the functions described herein. memory 1322 can also include storage device.

As shown in FIG. 13, high-speed circuitry 1318 includes high-speed processor 1320, memory 1322, and high-speed wireless circuitry 1324. In the example, the image display driver 1308 is coupled to the high-speed circuitry 1318 and operated by the high-speed processor 1320 in order to drive the left and right image displays of the image display of optical assembly 1304. high-speed processor 1320 may be any processor capable of managing high-speed communications and operation of any general computing system needed for head-wearable apparatus 1302. The high-speed processor 1320 includes processing resources needed for managing high-speed data transfers on communication 1336 to a wireless local area network (WLAN) using high-speed wireless circuitry 1324. In certain examples, the high-speed processor 1320 executes an operating system such as a LINUX operating system or other such operating system of the head-wearable apparatus 1302 and the operating system is stored in memory 1322 for execution. In addition to any other responsibilities, the high-speed processor 1320 executing a software architecture for the head-wearable apparatus 1302 is used to manage data transfers with high-speed wireless circuitry 1324. In certain examples, high-speed wireless circuitry 1324 is configured to implement Institute of Electrical and Electronic Engineers (IEEE) 802.11 communication standards, also referred to herein as Wi-Fi. In other examples, other high-speed communications standards may be implemented by high-speed wireless circuitry 1324.

The low power wireless circuitry 1330 and the high-speed wireless circuitry 1324 of the head-wearable apparatus 1302 can include short range transceivers (Bluetooth™) and wireless wide, local, or wide area network transceivers (e.g., cellular or WiFi). The client device 1338, including the transceivers communicating via the communication 1334 and communication 1336, may be implemented using details of the architecture of the head-wearable apparatus 1302, as can other elements of network 1340.

The memory 1322 includes any storage device capable of storing various data and applications, including, among other things, camera data generated by the left and right, infrared camera 1316, and the image processor 1310, as well as images generated for display by the image display driver 1308 on the image displays of the image display of optical assembly 1304. While memory 1322 is shown as integrated with high-speed circuitry 1318, in other examples, memory 1322 may be an independent standalone element of the head-wearable apparatus 1302. In certain such examples, electrical routing lines may provide a connection through a chip that includes the high-speed processor 1320 from the image processor 1310 or low power processor 1328 to the memory 1322. In other examples, the high-speed processor 1320 may manage addressing of memory 1322 such that the low power processor 1328 will boot the high-speed processor 1320 any time that a read or write operation involving memory 1322 is needed.

As shown in FIG. 13, the low power processor 1328 or high-speed processor 1320 of the head-wearable apparatus 1302 can be coupled to the camera (visible light camera 1312; infrared emitter 1314, or infrared camera 1316), the image display driver 1308, the user input device 1306 (e.g., touch sensor or push button), and the memory 1322.

The head-wearable apparatus 1302 is connected with a host computer. For example, the head-wearable apparatus 1302 is paired with the client device 1338 via the communication 1336 or connected to the server system 1332 via the network 1340. server system 1332 may be one or more computing devices as part of a service or network computing system, for example, that include a processor, a memory, and network communication interface to communicate over the network 1340 with the client device 1338 and head-wearable apparatus 1302.

The client device 1338 includes a processor and a network communication interface coupled to the processor. The network communication interface allows for communication over the network 1340, communication 1334 or communication 1336. client device 1338 can further store at least portions of the instructions for generating a binaural audio content in the client device 1338's memory to implement the functionality described herein.

Output components of the head-wearable apparatus 1302 include visual components, such as a display such as a liquid crystal display (LCD), a plasma display panel (PDP), a light emitting diode (LED) display, a projector, or a waveguide. The image displays of the optical assembly are driven by the image display driver 1308. The output components of the head-wearable apparatus 1302 further include acoustic components (e.g., speakers), haptic components (e.g., a vibratory motor), other signal generators, and so forth. The input components of the head-wearable apparatus 1302, the client device 1338, and server system 1332, such as the user input device 1306, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 1302 may optionally include additional peripheral device elements. Such peripheral device elements may include biometric sensors, additional sensors, or display elements integrated with head-wearable apparatus 1302. For example, peripheral device elements may include any I/O components including output components, motion components, position components, or any other such elements described herein.

For example, the biometric components include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), WiFi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over and communication 1336 from the client device 1338 via the low power wireless circuitry 1330 or high-speed wireless circuitry 1324.

Where a phrase similar to “at least one of A, B, or C,” “at least one of A, B, and C,” “one or more A, B, or C,” or “one or more of A, B, and C” is used, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Changes and modifications may be made to the disclosed embodiments without departing from the scope of the present disclosure. These and other changes or modifications are intended to be included within the scope of the present disclosure, as expressed in the following claims.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
accessing a camera image generated by an optical sensor of an augmented reality (AR) device;
accessing a query image from a storage of the AR device; and
identifying, using a feature detector program, the query image in the camera image without scaling the camera image.

2. The method of claim 1, further comprising:
scaling a detector window of the feature detector program; and
extracting features from the camera image by scanning the unscaled camera image with the scaled detector.

3. The method of claim 2, further comprising:
extracting features from the query image by scanning the query image with an unscaled detector.

4. The method of claim 3, further comprising:
comparing descriptors based on the extracted features from the camera image with descriptors based on the extracted features from the query image.

5. The method of claim 1, further comprising:
accessing a virtual content item corresponding to the query image; and
displaying the virtual content item in a display of the AR device.

6. The method of claim 1, further comprising:
generating the camera image using a wide-angle lens coupled to the optical sensor.

7. The method of claim 1, wherein the camera image includes a low resolution image.

8. The method of claim 1, wherein the feature detector program includes ORB (Oriented FAST and Rotated BRIEF) local feature detector.

9. The method of claim 1, wherein the feature detector program is configured to compare descriptors based on extracted features from the camera image using a scaled detector with descriptors based on extracted features from the query image using an unscaled detector.

10. The method of claim 1, wherein the query image includes marker data that indicate a pre-defined visual code.

11. A computing apparatus comprising:
a processor; and
a memory storing instructions that, when executed by the processor, configure the apparatus to:
access a camera image generated by an optical sensor of an augmented reality (AR) device;
access a query image from a storage of the AR device; and
identify, using a feature detector program, the query image in the camera image without scaling the camera image.

12. The computing apparatus of claim 11, wherein the instructions further configure the apparatus to:
scale a detector window of the feature detector program; and
extract features from the camera image by scanning the unscaled camera image with the scaled detector.

13. The computing apparatus of claim 12, wherein the instructions further configure the apparatus to:
extract features from the query image by scanning the query image with an unscaled detector.

14. The computing apparatus of claim 13, wherein the instructions further configure the apparatus to:
compare descriptors based on the extracted features from the camera image with descriptors based on the extracted features from the query image.

15. The computing apparatus of claim 11, wherein the instructions further configure the apparatus to:
access a virtual content item corresponding to the query image; and
display the virtual content item in a display of the AR device.

16. The computing apparatus of claim 11, wherein the instructions further configure the apparatus to:
generate the camera image using a wide-angle lens coupled to the optical sensor.

17. The computing apparatus of claim 11, wherein the camera image includes a low resolution image.

18. The computing apparatus of claim 11, wherein the feature detector program includes ORB (Oriented FAST and Rotated BRIEF) local feature detector.

19. The computing apparatus of claim 11, wherein the feature detector program is configured to compare descriptors based on extracted features from the camera image using a scaled detector with descriptors based on extracted features from the query image using an unscaled detector.

20. A non-transitory computer-readable storage medium, the computer-readable storage medium including instructions that when executed by a computer, cause the computer to:
access a camera image generated by an optical sensor of an augmented reality (AR) device;
access a query image from a storage of the AR device; and
identify, using a feature detector program, the query image in the camera image without scaling the camera image.
